(19) United States
(12) Patent Application Publication
(10) Pub. No.: US 2026/0275143 A1
(43) Pub. Date: Sep. 17, 2026

(54) STARCH COMPOSITION

(71) Applicant: CARGILL, INCORPORATED, Wayzata, MN (US)

(72) Inventors: John Andrew Bohlmann, Ottumwa, IA (US); Dogan Sahin Sivasligil, Overijse (BE)

(73) Assignee: CARGILL, INCORPORATED, Wayzata, MN (US)

(21) Appl. No.: 18/873,905

(22) PCT Filed: Jun. 14, 2023
(86) PCT No.: PCT/US2023/068437

§ 371 Date: Dec. 11, 2024

Related U.S. Application Data
(60) Provisional application No. 63/367,081, filed on Jun. 27, 2022.

(51) Int. Cl. C09D 103/02; C09J 103/02

(52) U.S. Cl. CPC C09D 103/02; C09J 103/02

(57) ABSTRACT

The present invention relates to starch compositions, methods of making starch compositions, methods of increasing the viscosity of a starch composition and uses of a starch composition. In particular, the present invention relates to a low-viscosity liquid starch composition that increases in viscosity upon the addition of water and associated methods and uses.

### CROSS-REFERENCE TO RELATED APPLICATIONS

This application claims the benefit of U.S. Provisional Application No. 63/367,081, filed Jun. 27, 2022, which is incorporated by reference herein in its entirety.

### FIELD OF THE INVENTION

The present invention relates to starch compositions, methods of making starch compositions, methods of increasing the viscosity of a starch composition and uses of a starch composition. In particular, the present invention relates to a low-viscosity liquid starch composition that increases in viscosity upon the addition of water and associated methods and uses.

### BACKGROUND OF THE INVENTION

Starch is a polymeric carbohydrate formed of repeating glucose units joined by glycosidic bonds. Starches, in various forms, are widely used, for example, as thickeners in the production of foods and beverages, as binders and/or bulking agents for pharmaceuticals and detergents, as a coating composition for paper, as rheology modifiers for adhesives and so on.

Starch solutions are widely used in the above applications. The viscosity of starch solutions increases by a process referred to as “starch gelatinization”, which is detailed in ROY L. WHISTLER, JAMES N. BEMILLER and EUGENE F. PASCHALL, STARCH Chemistry and Technology (1965). Briefly, starch gelatinization begins when the starch granules start to absorb water. This causes the starch granules to swell as water is drawn into the starch granule, which increases the viscosity of the starch solution. Maximum viscosity is reached when the starch granules are saturated with water reaching a point of maximum swelling. If the starch granule is pushed beyond the point of maximum swelling, the starch granule bursts resulting in complete gelatinization/solubilization of the starch material. Typically, the steps of starch gelatinization occur as the starch solution is heated (i.e., cooked) or if the starch is exposed to high levels of alkali. However, some starches are able to gelatinize, swell and/or solubilize at room temperature meaning that no heating/cooking or alkali is necessary.

Starches are typically provided in either a dry powder form or an aqueous solution. Preferably, starches are provided as aqueous solutions since they can be easier to handle, safer and easier to mix with other reagents. However, when preparing aqueous starch solutions by adding water to a starch material, starches either create a starch suspension requiring heating/cooking or contact with an alkali to initiate gelatinization or, if the starch is soluble at ambient temperatures, immediately gelatinize, swell and/or solubilize to form highly viscous, gel-like compositions that are difficult to handle.

Starch solutions that require heating/cooking/the presence of an alkali to initiate gelatinization, such as native or low-level modified starches, are typically provided as a dry powder. Water is subsequently added and gelatinization initiated by heating/cooking/contact with an alkali. The problem with this is that heating/cooking is not possible in all locations and so downstream use of these starch solutions is limited to sites that can heat/cook starch solutions. Heating/cooking also requires the use of energy and so these methods are not environmentally friendly. Moreover, addition of an alkali very quickly causes gelatinization, swelling and/or solubilization of the starch solution meaning that solutions contacted with an alkali become very viscous in a short period of time. The resulting starch solutions are so viscous that they are difficult to package, transport, store and mix with other reagents. If the alkali is added by the end user, the end user will need to handle highly alkaline solutions to initiate gelatinization. Practically, it is also difficult for an end-user to use starch solutions that require the addition of alkaline solutions to initiate gelatinization as the starch material is gelatinized and/or solubilized very quickly, which is associated with the production of a highly viscous solution, which is difficult to handle and work with.

The problem with starches that gelatinize, swell and/or solubilize immediately upon the addition of water, such as highly modified starches, is that the resulting starch composition is so viscous that it is difficult to package, transport and store the starch solution and mix the solution with other reagents.

There is a need to provide a starch solution with a high dry solid content (and low water content) while keeping the viscosity at an acceptable level (i.e., the starch does not immediately gelatinize upon contact with water or alkali) so that the starch solution can be easily provided to the end user and subsequently used without having to cook the solution.

WO 2010/133324 A1 discloses an aqueous composition characterised in that it comprises one or more anionic polysaccharides suspended in an aqueous dispersion of one or more hydrocolloids, and in that at a pH of 3 or less, the composition has a Brookfield viscosity (A) of less than 5000 mPas; and that at a pH of 6 or more, the composition has a Brookfield viscosity (B) which is at least five times greater than (A). Altering the pH of the composition ensures that the composition can be transported, stored and handled at the lower viscosity and, upon increasing the pH, the composition can be used by the end user at a higher viscosity. However, a problem with this composition is that, to increase the viscosity, the user has to add an alkaline substance (e.g., sodium hydroxide (NaOH)) or mix the composition with another composition that is alkaline in pH. As mentioned above, it is very difficult for an end-user to use stock starch solutions that require the addition of alkaline solutions to initiate gelatinization as the starch material is gelatinized and/or solubilized very quickly upon contact with the alkaline solution. This is a disadvantage because a highly viscous solution is produced, which is difficult to handle and work with in down-stream applications.

EP2999718 B1 discloses an aqueous composition comprising an aqueous phase and a cold-water soluble starch material, characterised in that the aqueous phase comprises at least a viscosity inhibitor and a hydrocolloid; and in that the starch material is dispersed throughout the aqueous phase. A problem with this composition is that only cold-water starch materials can be used—i.e., starch materials that are capable of gelatinizing, swelling and/or solubilization in water at ambient temperature (e.g. 20° C.).

These compositions cannot be used with starches that require heating/cooking or high levels of alkali to gelatinize, swell and/or solubilize in water. Therefore, there is a need for improved starch solutions that can be used with a wider range of starches.

The present invention provides an improved starch composition that addresses the problems associated with the prior art.

### SUMMARY OF THE INVENTION

Representative features of the present invention are set out in the following clauses, which stand alone or may be combined, in any combination, with one or more features disclosed in the text and/or figures of the specification.

The present invention is as set out in the following clauses:
1. A liquid composition comprising:
   starch;
   a gelatinization inhibitor;
   a gelatinization promoter comprising an alkali; and
   a balance amount of water up to 100% by weight.
2. The composition of clause 1, wherein gelatinization of the starch occurs and/or the Brookfield viscosity of the composition increases upon the addition of water until the concentration of the gelatinization promoter falls below a critical concentration (X).
3. The composition of clause 1 or 2, wherein gelatinization of the starch occurs and/or the Brookfield viscosity increases upon the addition of water by decreasing the concentration of the gelatinization inhibitor below a critical concentration (Y) whereat the gelatinization promoter is able to promote gelatinization of the starch when the concentration of the gelatinization promoter is at or above the critical concentration (X).
4. The composition of clause 3, wherein the composition has a Brookfield viscosity (A) of less than 5000 mPas at 20-25° C. and at 100 rpm where the gelatinization inhibitor is at or above the critical concentration (Y) and a viscosity (B) that is greater than (A) where the gelatinization inhibitor is below the critical concentration (Y) and the gelatinization promoter is at or above the critical concentration (X).
5. The composition of clause 4, wherein Brookfield viscosity (B) is at least two times greater than Brookfield viscosity (A).
6. The composition of clauses 4 or 5, wherein the composition has a Brookfield viscosity (C) that is less than viscosity (A) and/or (B) whereat the concentration of the gelatinization promoter is below the critical concentration (X).
7. The composition of any preceding clause wherein gelatinization of the starch occurs at temperatures above 30° C.
8. The composition of any preceding clause, wherein the starch is a native starch.
9. The composition of clause 8, wherein the native starch is selected from the group consisting of wheat starch, com starch, waxy starch, potato starch, pea starch, cassava starch, rice starch, sorghum starch, barley starch or mixtures of two or more thereof.
10. The composition of any one of clauses 1-7, wherein the starch is a modified starch.
11. The composition of clause 10, wherein the modified starch is selected from the group consisting of oxidized starches, acid thinned starches, thermally modified starches, a starch ether or mixtures of two or more thereof.
12. The composition of clause 11, wherein the starch ether is selected from the group consisting of: cationic starches, hydroxypropylated starches, crosslinked starches, anionic starches or mixtures of two or more thereof.
13. The composition of any preceding clause, wherein the starch is present in an amount of up to 45% by weight, preferably up to 35% by weight, even more preferably up to 25% by weight.
14. The composition of any preceding clause, wherein the gelatinization inhibitor is water soluble.
15. The composition of any preceding clause, wherein the gelatinization inhibitor is selected from the group consisting of: carbohydrates, alcohols, polyols, synthetic polymers and/or oligomers, amines, amides or mixtures of two or more thereof.
16. The composition of any preceding clause, wherein the gelatinization inhibitor comprises a carbohydrate selected from the group consisting of: glucose, fructose, sugar syrups, sucrose, maltodextrins, lactose, galactose, xylose, arabinose, ribose, hemicellulose syrups, cellulose syrups or mixtures of two or more thereof.
17. The composition of clause 16, wherein the gelatinization inhibitor comprises glucose syrup.
18. The composition of any preceding clause, wherein the gelatinization inhibitor comprises a polyol selected from the group consisting of: glycol, glycerol, sorbitol, mannitol, maltitol, Xylitol, erythritol, sugar alcohols, propylene glycol, ethylene glycol (EG), diethylene glycol (DEG), triethylene glycol (TEG), tetraethylene glycol or mixtures of two or more thereof.
19. The composition of clause 18, wherein the gelatinization inhibitor comprises glycerol.
20. The composition of any preceding clause, wherein the gelatinization inhibitor comprises an amine or amide selected from the group consisting of: urea, formamide, an alkanol amine, ethanolamine, triethanolamine or polyamines or mixtures of two or more thereof.
21. The composition of any preceding clause, wherein the gelatinization inhibitor is present in an amount of up to 70% by weight, preferably up to 60% by weight, even more preferably 50% by weight.
22. The composition of any preceding clause, wherein the gelatinization promoter is configured to cause the pH of the composition to be alkaline, preferably at a pH of 11 or more.
23. The composition of any preceding clause, wherein the gelatinization promoter is sodium hydroxide, potassium hydroxide, calcium hydroxide, sodium carbonate, ammonium hydroxide, potassium carbonate, barium hydroxide, a sodium silicate or mixtures of two or more.
24. The composition of any preceding clause, wherein the gelatinization promoter is present in an amount of up to 25% by weight, preferably up to 5% by weight.
25. The composition of any preceding clause, wherein water content is 70% by weight or less, preferably wherein the water content is 30% by weight or less.
26. The composition of any preceding clause, wherein the composition comprises:
   a. the gelatinization inhibitor at a weight percentage of from 35 to 70%;
   b. starch at a weight percentage of from 20 to 35%;
   c. the gelatinization promoter at a weight percentage of from 2 to 20%; and
   d. water as the balance.
27. The composition of clause 26, wherein:
   a. the gelatinization inhibitor is glycerol, sorbitol, a sugar or glucose syrup;
   b. the starch is com starch or wheat starch; and
   c. the gelatinization promoter is sodium hydroxide.
28. The composition of clause 26 or 27, wherein the composition comprises:
   a. glycerol at a weight percentage of 50%;
   b. corn starch at a weight percentage of 25%;
   c. sodium hydroxide at a weight percentage of 5%; and
   d. water at a weight percentage of 20%.
29. The composition of clause 26 or 27, wherein the composition comprises:
   a. glucose syrup at a weight percentage of 40%;
   b. corn starch at a weight percentage of 25%;
   c. sodium hydroxide at a weight percentage of 5%; and
   d. water at a weight percentage of 30%.
30. The composition of any preceding clause, wherein the composition has a pH of above 7, preferably a pH of 11 or more.
31. The composition of any preceding clause further comprising a polymer, preferably a latex, such as Styrene-butadiene latex or polyvinyl alcohol.
32. A method of manufacturing the composition of any of clauses 1-31, comprising mixing the starch, gelatinization inhibitor and gelatinization promoter with water.
33. The method of clause 32, wherein the method comprises adding the gelatinization inhibitor to a pre-prepared mixture of water and gelatinization promoter and mixing and subsequently adding the starch material and mixing.
34. The method of clause 32, wherein the method comprises:
   a. mixing the gelatinization inhibitor with water;
   b. adding the starch and mixing to produce an even suspension; and
   c. adding the gelatinization promoter and mixing.
35. The method of clauses 32-34, further comprising adding a polymer to the composition and mixing, preferably wherein the polymer is a latex.
36. A method of promoting gelatinization and/or increasing the viscosity of the composition of any one of clauses 1-31, the method comprising adding water to the composition or vice versa.
37. The method of clause 36, wherein the water or composition is added to the composition or water, respectively, in two or more additions.
38. The method of clause 36 or 37, wherein water or the composition is added to the composition or water, respectively, until the concentration of gelatinization promoter is at critical concentration (X).
39. The method of clauses 36-38, wherein water or the composition is added to the composition or water, respectively, to achieve a ratio of composition:water within the range of from 1:0.1 to 1:100.
40. The method of clause 39, wherein the ratio of composition:water is within the range of from 1:0.1 to 1:5.
41. The method of any one of clauses 36-40, comprising a first step comprising adding water or the composition to the composition or water, respectively, to produce a first diluted composition with a ratio of composition:water within the range of from 1:0.1 to 1:5; and further comprising one or more steps of adding water or the first diluted composition to the first diluted composition or water, respectively, to produce a final diluted composition with a ratio of composition:water within a range of 1:0.1 to 1:100.
42. A diluted composition comprising the composition of any of clauses 1-32 and water at a ratio of composition:water within the range of from 1:0.1 to 1:100.
43. An aqueous composition produced by the method of any one of clauses 32-41.
44. Use of the composition of any of clauses 1-31, 42 or 43.
45. Use of the composition according to clause 44, wherein the composition is used: as an adhesive, a binder, a coating, a paper coating, in paper making, a rheology modifier, a 3D-printing material, a sealant, a material to develop a foam, to enhance oil recovery, in fertilizers, on seeds, to restrict distribution of a substance, to restrict the spread of particulates and/or solids or as a suspension aid.

### DETAILED DESCRIPTION

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred systems and methods are now described.

Some of the terms used to describe the present invention are set out below:

“Balance amount of water” refers to the amount of water used in the composition to ensure the weight percentage of the composition is made up to 100%. For example, if the composition contains components that total a weight percentage of 70%, the balance amount of water added to the composition would be 30%. It would fall within the skilled person's common general knowledge to be able to determine the balance amount of water needed and act accordingly.

“Critical concentration” refers to either:
the minimum concentration of gelatinization promoter that is required to promote gelatinization, swelling and/or solubilization of the starch (critical concentration X); or
the minimum concentration of gelatinization inhibitor that is required to prevent the starch in the composition from gelatinization, swelling and/or solubilization (critical concentration (Y).

Upon addition of water, the concentration of gelatinization promoter and gelatinization inhibitor will reduce due to dilution of the composition. If the resulting concentration of gelatinization inhibitor is at or above the critical concentration (Y), there will be sufficient levels of the gelatinization inhibitor to prevent the starch from undergoing gelatinization, swelling and/or solubilizing via the actions of the gelatinization promoter regardless of whether the gelatinization promoter is at, above or below critical concentration (X). However, once the concentration of gelatinization inhibitor falls below critical concentration (Y) and the concentration of gelatinization promoter is at or above critical concentration (X), the gelatinization promoter will be able to cause gelatinization, swelling and/or solubilization of the starch thus increasing the viscosity of the composition. If the amount of water added is enough to result in the concentration of the gelatinization promoter to fall below critical concentration (X), regardless of whether the concentration of the gelatinization inhibitor is at, above or below critical concentration (Y), the viscosity of the composition will decrease. It would be clear to the skilled person that critical concentrations (X) and (Y) will be dependent on a number of factors, for example, the type of starch, gelatinization inhibitor and gelatinization promoter used in the composition, temperature and the methods used to dilute the composition. The skilled person would be able to determine critical concentrations (X) and (Y) for a particular starch composition by measuring the viscosity of the starch composition with varying concentrations of gelatinization inhibitor and/or gelatinization promoter. For example, to determine the critical concentration (X) of gelatinization promoter, the skilled person could produce serial-fold dilutions (using a particular dilution method) of a starch composition with a known amount of gelatinization promoter and measure the viscosity of each diluted sample. The amount of gelatinization promoter can be calculated based on the level of dilution (for example, adding an equal volume of water to a composition comprising 5% by weight gelatinization promoter will produce a diluted composition containing 2.5% by weight gelatinization promoter). The viscosity of the diluted solutions can be measured and critical concentration (X) determined by identifying the level of dilution that results in loss of an ability to promote gelatinization. The skilled person would readily be able to compare the diluted solutions to an identical starch composition lacking a gelatinization promoter to ascertain the levels of viscosity indicative of a starch composition that is unable to gelatinize. A similar approach can be used to determine the critical concentration (Y) of gelatinization inhibitor. Starch compositions with a fixed level of gelatinization promoter (for example 5% by weight) can be produced with varying weight percentages of gelatinization inhibitor, for example 50%, 40%, 30%, etc., and the viscosity of these solutions can be measured. A composition with a particular weight percentage of gelatinization inhibitor that is able to gelatinize and become more viscous is below critical concentration (Y) and a composition with a particular weight percentage of gelatinization inhibitor that does not gelatinize is at or above critical concentration (Y). By preparing solutions with varying weight percentages of gelatinization inhibitor and comparing the viscosities of these solutions, the skilled person can readily determine the minimum weight percentage of gelatinization inhibitor required to prevent gelatinization of the starch material and hence determine critical concentration (Y).

“Gelatinization promoter” refers to any compound which, when used in accordance with the present invention, is capable of raising the viscosity of the composition by initiating gelatinization of the starch material in the composition compared to an otherwise equivalent composition in the absence of the gelatinization promoter. The gelatinization promoter is able to initiate gelatinization to promote granular swelling of the starch material thus increasing the viscosity of the composition. The gelatinization promoter can cause maximum swelling of the starch granule and eventual bursting of the starch granule. The result of granule bursting is solubilization of the starch material. Therefore, the composition of the present invention will be considered to have increased swelling, gelatinization and/or viscosity compared to its gelatinization promoter-free equivalent if the concentration of the gelatinization promoter is at or above critical concentration (X) and the concentration of the gelatinization inhibitor is below critical concentration (Y)). Explained in another way, a gelatinization promoter will be capable of promoting or increasing the swelling, gelatinization and/or solubilization of the starch material in the composition to increase the viscosity of the composition if the right balance between critical concentrations (X) and (Y) is met. Examples of gelatinization promoters include: sodium hydroxide, potassium hydroxide, calcium hydroxide, sodium carbonate, ammonium hydroxide, potassium carbonate, barium hydroxide, sodium silicate or mixtures of two or more.

“Gelatinization inhibitor” refers to any compound which, when used at or above critical concentration (Y) in accordance with the present invention, is capable of preventing the gelatinization, swelling and/or solubilization of the starch material in the composition compared to an otherwise equivalent composition in the absence of the gelatinization inhibitor (thus the composition of the present invention will be considered to have a reduced viscosity compared to its gelatinization inhibitor-free equivalent). Explained in another way, a gelatinization inhibitor will be capable of preventing or limiting the swelling, gelatinization and/or solubilization of the starch material in the composition if the concentration of the gelatinization inhibitor is at or above critical concentration (Y) thus maintaining the low-viscosity levels of the composition. Examples of gelatinization inhibitors include: carbohydrates, alcohols, polyols, synthetic polymers and/or oligomers, amines, amides or mixtures of two or more thereof, for example glucose, fructose, sugar syrups, sucrose, maltodextrins, lactose, galactose, xylose, arabinose, ribose, hemicellulose syrups, cellulose syrups, glycol, glycerol, sorbitol, mannitol, maltitol, Xylitol, erythritol, sugar alcohols, propylene glycol, ethylene glycol (EG), diethylene glycol (DEG), triethylene glycol (TEG), tetraethylene glycol, urea, formamide, an alkanol amine, ethanolamine, triethanolamine or polyamines.

“Gelatinization, swelling or solubilizing” refers to the various stages in the process of “starch gelatinization” whereby “gelatinization” is initiated by starch granules absorbing water and increasing in size (i.e., “swelling”) until they reach a point of “maximum swelling” (i.e., when the starch granules are saturated with water). As the starch granules absorb water and swell, the amount of water in the composition reduces causing an increase in viscosity. The starch solution is at its most viscous once maximum swelling has been reached. Above maximum swelling, the starch granules eventually rupture and burst, which causes the starch to go into solution (“solubilization”) causing the starch composition to slightly decrease in viscosity resulting in complete gelatinization of the starch material. For starches that are not swellable or soluble in cold water, increasing the temperature or pH of the solution will cause gelatinization, swelling and/or solubilization of the starch.

“Liquid composition” generally refers to a composition that is liquid above a certain water content. However, the skilled person would appreciate that some substances, for example, ethanol and glycerol, are liquid despite the presence of water.

“Maximum swelling”, in the context of the present invention, refers to the point at which the starch granules in the starch solution have absorbed the maximum amount of water possible i.e., they are saturated. At this point, the starch solution will be at its most viscous. If the starch granules absorb more water, this will result in the starch granules bursting causing solubilization of the starch material and the production of a highly viscous starch paste. Such a starch paste has a lower level of viscosity compared to the starch solution at maximum swelling, but the viscosity will be higher than that of the starch solution before gelatinization occurred.

“Modified starch” refers to a native starch that has been exposed to physical, enzymatic or chemical treatment to change the properties of the native starch. For example, a native starch may be modified to increase stability against excessive heat. Non-limiting examples of modified starches include: oxidized starches, acid thinned starches, Thermally modified starches, a starch ether (for example, cationic starches, hydroxypropylated starches, crosslinked starches, anionic starches) or mixtures of two or more thereof.

“Native starch” as used herein, is a starch as it is found in nature, for example from plants. Typical sources for these starches are cereals, tubers and roots, legumes (including pea, chick pea, lentils, fava beans, lupin bean, and mung bean) and fruits. The native source can be any variety, including without limitation, corn, potato, sweet potato, barley, wheat, rice, sago, Kudzu, amaranth, tapioca (cassava), arrowroot, canna, pea, banana, quinoa, oat, rye, millet, triticale and sorghum, as well as low amylose (waxy) and high amylose varieties thereof.

“Percentage (%) by weight” refers to the percentage weight in grams of a component of a composition for every 100 grams of a composition. For example, if a composition contained starch at 10% by weight, then there is 10 g of starch for every 100 g of composition.

“Polymer” refers to a substance or material consisting of very large molecules, or macromolecules, composed of repeating subunits.

“Polyol” refers to an alcohol containing multiple hydroxyl groups. Non-limiting examples include glycol, glycerol and sorbitol.

“Ratio of composition:water” refers to the relative amounts of initial/stock composition and water used to produce a diluted composition with increased viscosity. For example, if the diluted composition comprises a 1:1 ratio of composition:water then the diluted composition contains equal parts in weight of initial composition and water whereas if the diluted composition comprises a 1:10 ratio of composition:water then the diluted composition contains 1 part initial composition and 10 parts water.

### Starch Composition

An aspect of the present invention relates to improved starch compositions.

The starch compositions of the present invention are able to increase in viscosity upon the addition of water. This is achieved as the addition of water decreases the concentration of the gelatinization inhibitor such that the alkali comprised in the gelatinization promoter can initiate the gelatinization process of the starch material. During gelatinization of the starch material, the starch absorbs water and begins to swell, which results in an increase in viscosity. Maximum viscosity is reached when the starch granules reach maximum swelling. Since the viscosity of the composition is increased by the addition of water, the composition can be transported, supplied and stored as a stock composition having a lower viscosity while maintaining a high starch percentage and low water content and the viscosity of the composition can be subsequently increased by the addition of water. This avoids the complications associated with transporting highly viscous compositions typical of starch compositions that immediately gelatinize in the presence of alkali and/or water and also avoids having to increase viscosity using potentially hazardous pH-altering chemicals. Additionally, no cooking of the starch is required to initiate the gelatinization process meaning that the starch compositions of the invention can be used by all end users, regardless of whether they have the facilities to heat/cook the starch composition, which has environmental benefits as no energy is required to heat/cook the starch composition. Moreover, gelatinization of the starch can be achieved directly by the end user by mixing with water. For example, by spraying or coating of the composition on a wet surface results in immediate gelatinization and fixation of the starch material on the surface or vice versa by adding or spraying water on a surface of a material that contains the composition.

The starch compositions of the present invention thus represent an improvement over known starch compositions.

In some examples, the Brookfield viscosity of the composition increases upon the addition of water until the concentration of the gelatinization promoter falls below a critical concentration (X). Preferably, the Brookfield viscosity of the composition increases upon the addition of water by decreasing the concentration of the gelatinization inhibitor below a critical concentration (Y) whereat the gelatinization promoter is able to promote gelatinization of the starch when the concentration of the gelatinization promoter is at or above critical concentration (X). Even more preferably, the composition has a Brookfield viscosity (A) of less than 5000 mPas at 20-25° C. and at 100 rpm using an appropriate spindle where the gelatinization inhibitor is at or above critical concentration (Y) and a viscosity (B) that is greater than (A) (for example, at least two time greater than (A)) where the gelatinization inhibitor is below the critical concentration (Y) and the concentration of the gelatinization promoter is at or above critical concentration (X) and a Brookfield viscosity (C) that is less than viscosities (A) and/or (B) where at the concentration of the gelatinization promoter is below critical concentration (X).

In some examples, gelatinization of the starch occurs at temperatures above 30° C. This has the advantage that the composition will have a low viscosity at temperatures at or around room temperature as gelatinization of the starch material cannot occur immediately at temperatures at or around room temperature. Once the level of gelatinization inhibitor is below critical concentration (Y), and the concentration of the gelatinization promoter is above critical concentration (X), the gelatinization promoter can then function to initiate gelatinization, swelling and/or solubilization of the starch. This avoids the use of having to use high temperatures to cause gelatinization, swelling and/or solubilization of the starch and ensures that viscosity of the composition remains low, which has the advantage that the composition can be transported, handled and used in down-stream applications easily.

In some examples, the starch is a native starch, preferably wheat starch, com starch, waxy starch, potato starch, pea starch, cassava starch, rice starch, sorghum starch, barley starch or mixtures of two or more thereof. Alternatively, the starch is a modified starch, preferably oxidized starches, acid thinned starches, thermally modified starches, a starch ether (for example cationic starches, hydroxypropylated starches, crosslinked starches (crosslinked by, for example: urea formaldehyde resins, epichlorohydrin, poly glycidyl ethers, sodium trimetaphosphate, polyphosphates), anionic starches or mixtures of two or more thereof) or mixtures of two or more thereof. In some examples, the starch contains multiple levels of modification, i.e., can contain any of the modifications indicated above for the modified starches. Non-limiting examples include cross linked cationic starches or a thinned hydroxypropylated starches or a cross linked starch ether. In some examples, the starch is selected from the list consisting of: wheat starch or corn starch.

In some examples, the starch is present in an amount of up to 45% by weight, preferably 25% by weight. In some examples, the starch is present in an amount of from 5% to 45% by weight. In some examples, the starch is present in an amount of from 15% to 35% by weight. In some examples, the starch is present in an amount of from 20% to 30% by weight. In some examples, the starch is present at 5%, 10%, 15%, 20%, 25%, 30%, 35%, 40% or 45% by weight. In some examples, the starch is present at 25% by weight.

In some examples, the gelatinization inhibitor is water soluble. Preferably, the gelatinization inhibitor is selected from the group consisting of carbohydrates, alcohols, polyols, synthetic polymers and/or oligomers, amines, amides or mixtures of two or more thereof.

Preferably, the gelatinization inhibitor comprises a carbohydrate selected from the list consisting of: glucose, fructose, sugar syrups, sucrose, maltodextrins, lactose, galactose, xylose, arabinose, ribose, hemicellulose syrups, cellulose syrups or mixtures of two or more thereof. Alternatively, the gelatinization inhibitor comprises a polyol selected from the group consisting of: glycol, glycerol, sorbitol, mannitol, maltitol, Xylitol, erythritol, sugar alcohols, propylene glycol, ethylene glycol (EG), diethylene glycol (DEG), triethylene glycol (TEG), tetraethylene glycol or mixtures of two or more thereof. Alternatively, the gelatinization inhibitor comprises an amine or amide selected from the group consisting of urea, formamide, an alkanol amine, ethanolamine, triethanolamine or polyamines or mixtures of two or more thereof.

In some examples, the gelatinization inhibitor is present in an amount of up to 70% by weight, preferably up to 50% by weight. In some examples, the gelatinization inhibitor is present in an amount of from 5% to 70% by weight. In some examples, the gelatinization inhibitor is present in an amount of from 20% to 70% by weight. In some examples, the gelatinization inhibitor is present in an amount of from 20% to 60% by weight. In some examples, the gelatinization inhibitor is present in an amount of from 30% to 50% by weight. In some examples, the gelatinization inhibitor is present in an amount of from 40% to 50% by weight. In some examples, the gelatinization inhibitor is present at 5%, 10%, 15%, 20%, 25%, 30%, 35%, 40%, 45%, 50%, 55%, 60%, 65%, 70% by weight. In some examples, the gelatinization inhibitor is present at 50% by weight.

In some examples, the gelatinization promoter is configured to cause the pH of the composition to be alkaline, preferably the pH is above 7, more preferably at least 8, more preferably at least 9, more preferably at least 10, most preferably at a pH of 11 or more. Preferably, the gelatinization promoter is sodium hydroxide, potassium hydroxide, calcium hydroxide, sodium carbonate, ammonium hydroxide, potassium carbonate, barium hydroxide, a sodium silicate or mixtures of two or more.

In some examples, the gelatinization promoter is present in an amount of up to 25% by weight, preferably up to 5% by weight. In some examples, the gelatinization promoter is present in an amount of from 0.5% to 25% by weight. In some examples, the gelatinization promoter is present in an amount of from 3% to 20% by weight. In some examples, the gelatinization promoter is present in an amount of from 3% to 10% by weight. In some examples, the gelatinization promoter is present in an amount of 5% by weight.

In some examples, the water content is 70% by weight or less, preferably wherein the water content is below 50%% by weight. Even more preferably, the water content is below 30% by weight. The skilled person would readily be able to determine the amount of water required to ensure that the weight percentage of the composition is equal to 100%. In some examples, the water content is from 15% to 70% by weight. In some examples, the water content is from 20% to 60% by weight. In some examples, the water content is from 30% to 50% by weight. In some examples, the water content is 15%, 20%, 25%, 30%, 35%, 40%, 45%, 50%, 60%, 65% or 70% by weight. In some examples, the water content is 20% by weight.

In an example, the composition comprises the gelatinization inhibitor at a weight percentage of from 35 to 70%; starch at a weight percentage of from 20 to 35%; the gelatinization promoter at a weight percentage of from 2 to 20%; and water as the balance. Preferably, the gelatinization inhibitor is glycerol, sorbitol, a sugar or glucose syrup; the starch is corn starch or wheat starch; and the gelatinization promoter is sodium hydroxide. Even more preferably, the composition comprises glycerol or glucose syrup at a weight percentage of 50% or 40%, respectively, corn starch or wheat starch at a weight percentage of 25%, sodium hydroxide at a weight percentage of 5% and water at a weight percentage of 30%.

In some examples, the composition has a pH of above 7, preferably a pH of 11 or more. In some examples, the pH of the composition is from 7 to 14. In some examples, the pH of the composition is from 11 to 14. In some examples, the pH of the composition is from 12 to 14. In some examples, the pH of the composition is 7, 8, 9, 10, 11, 12, 13 or 14. In some examples, the pH of the composition is 13.

In some examples, the composition further comprises a polymer. Preferably, the composition further comprises a latex such as Styrene butadiene (SBR) latex or a polyvinyl alcohol.

### Method of Manufacturing the Composition

Another aspect of the present invention relates to a method of manufacturing the composition. The method of manufacturing the composition comprises mixing the starch, gelatinization inhibitor and gelatinization promoter with water. In an embodiment, the gelatinization inhibitor can be added to, and subsequently mixed with, a pre-prepared mixture of water and gelatinization promoter and the starch material can be added, and mixed, subsequently. Preferably, the method comprises a method of manufacturing the composition in the following steps:
1. Mixing the gelatinization inhibitor with water;
2. Adding starch to and mixing to produce an even suspension; and
3. Adding the gelatinization promoter and mixing.

In some examples, further ingredients can be added to the composition. Preferably, a polymer is added to the composition. Preferably, the polymer is a latex.

An aspect of the invention also relates to compositions produced by the above methods of manufacturing.

### Method of Increasing the Viscosity of the Composition

Another aspect of the invention relates to a method of increasing the viscosity of the composition. The method comprises adding water to the composition. Alternatively, the method comprises adding the composition to water.

In some examples, the water or composition added to the composition or water, respectively, is added in two or more additions i.e., in a step-wise manner.

In some examples, the water or composition is added up to the point at which maximum swelling and/or solubilization of the starch is reached. Alternatively, an amount of water or composition can be added to reach a desired level of viscosity, which is below the viscosity achieved at maximum swelling and/or solubilization of the starch material.

In some examples, the water or composition is added to achieve a ratio of composition:water within the range of from 1:0.1 to 1:100, preferably within the range of from 1:01 to 1:5.

In some examples, the method comprises a first step comprising adding water of the composition to the composition or water, respectively, to produce a first diluted composition with a ratio of composition:water within the range of from 1:0.1 to 1:5; and further comprising one or more steps of adding water or the first diluted composition to the first diluted composition or water, respectively, to produce a final diluted composition with a ratio of composition:water within the range of from 1:0.1 to 1:100.

An aspect of the invention also relates to diluted compositions produced by the above methods of increasing the viscosity of the (stock) composition.

### Diluted Compositions

A further aspect of the invention relates to diluted compositions comprising the stock composition mentioned above and water at a ratio of composition:water within the range from 1:0.1 to 1:100. Adding water to the stock composition produces a diluted composition that has a viscosity that is higher than that of the stock composition. These diluted compositions can be used by end-users that require the composition to be of a higher viscosity. The skilled person would appreciate that water does not have to be physically added to the composition to increase the viscosity/promote gelatinization/solubilization of the starch material and that the composition merely has to come into contact with water to be able to promote gelatinization of the starch solution and the associated increase in viscosity. For example, the stock composition could come into contact with water during use (e.g., by spraying, inline mixing, etc.) without producing a second stock solution. In a particular example, a material could be coated with the composition or water and then subsequently sprayed with water or the composition, respectively, to promote gelatinization of the starch material and the associated increase in viscosity directly on the material.

### Uses of the Composition

A further aspect of the invention relates to the use of the composition. Preferably, the composition is used as an adhesive, a binder, a coating, a paper coating, in paper making, a rheology modifier, a 3D-printing material, a sealant, a material to develop a foam, to enhance oil recovery, in fertilizers, on seeds, to restrict distribution of a substance, to restrict the spread of particulates and/or solids or as a suspension aid.

### EXAMPLES

The following are non-limiting examples that discuss, with reference to tables, the advantages of the present invention. The examples set forth herein are merely examples among other possible examples.

### Example 1: Making a Corn Starch Composition

A liquid starch composition according to the present invention was prepared.

In this non-limiting example, a composition in accordance with the present invention was prepared using the following method:
1. 27.3 g of water was added to a beaker. 252.5 g of glycerol (99% dry solid) was added and the composition was agitated with a IKA RW28 with R 1324 propeller stirrer for 1 minute at 800 revolutions per minute (rpm) at room temperature.
2. 142.05 g of Corn Starch material (C*Gel 03401 (88% dry substance) from Cargill) was slowly added to the composition of step 1 and agitated as above for 1 minute until an even suspension was achieved.
3. 78.1 g of sodium hydroxide solution (32% dry solid) was added to the composition of step 2 and agitated as above for 1 minute.
4. The resulting composition was stirred for a further 5 minutes.

The resulting composition (Composition 1) had a dry solid percentage of 80% with a water content of 20% with a Brookfield viscosity (100 rpm) of 277 mPas.

The ingredients and properties of composition 1 are detailed in Table 1. The Brookfield viscosity was measured by placing the composition in a 600 mL glass beaker and adjusting the temperature to 20° C. Depending on the viscosity of the composition, a spindle is selected according to the manufacturer's instructions and fixed carefully on a Brookfield Viscometer DV-II+. The glass beaker is then placed on the viscometer (set at 100 rpm) so that the spindle is at least partially covered by the sample. The viscosity of the sample was then measured following the manufacturer's instructions.

TABLE 1

| Table 1 | Composition 1 |
|---|---|
| Water | 27.3 |
| Glycerol | 252.53 |
| Starch material (C*Gel 03401 from Cargill) | 142.05 |
| Sodium hydroxide solution | 78.13 |
| Total dry solids (%) | 80 |
| Brookfield viscosity (10 minutes after production) | 277.6 |
| pH | 13.1 |

As shown in Table 1, the composition has a high dry solid percentage (i.e., 80%) whilst also having acceptable viscosity levels. The present invention thus provides a composition with high starch concentrations that are not so viscous that they are unmanageable. The compositions of the present invention are thus extremely easy to handle and can be transported, handled and stored ready for downstream applications.

### Example 2: Increasing the Viscosity of Starch Composition 1

The following non-limiting example describes how the viscosity of the starch composition listed as “composition 1” in Table 1 was increased.

Specifically, an equal amount (100 g) of starch composition 1 and water were combined and mixed producing a composition with a ratio of composition:water of 1:1. The addition of water decreased the concentration of glycerol to below a concentration where it was able to inhibit gelatinization of the Corn Starch whilst maintaining a concentration of NaOH sufficient to promote gelatinization of the Corn Starch resulting in the production of a highly viscous gel/paste due to gelatinization of the Corn Starch. The resulting starch solution was so thick that the viscosity was difficult to measure. However, the viscosity would be greater than 15000 mPas, as viscosities lower than this can readily be measured.

### Example 3: Making a Wheat Starch Composition

A further non-limiting starch composition was prepared.

The starch composition (composition 2) was prepared using the method used in Example 1 except that Wheat Starch (C*Flex 20002 (88.2% dry solids) from Cargill) was used in place of Corn Starch. A corresponding starch composition (composition 3) lacking NaOH (gelatinization promoter) was also produced. The ingredients and properties of each composition are shown in Table 2.

TABLE 2

| Ingredient | Composition 2 | Composition 3 |
|---|---|---|
| Water | 27.30 | 27.3 |
| C*Flex 20002 (Wheat Starch) | 142.05 | 142.05 |
| Glycerol | 252.50 | 252.50 |
| Sodium hydroxide solution | 78.1 | 0 |
| Total | 499.95 | 421.85 |
| Total dry solids (%) | 80 | 88 |
| pH | 12.8 | 7.9 |
| Viscosity | 326 | 690* |

*This viscosity of composition 3 was greater than that of composition 2 due to the higher percentage of solids in the composition.

### Example 4: Increasing the Viscosity of Composition 2

Water was added to compositions 2 and 3 to produce diluted compositions with the following ratios of composition:water: 1:0.5 (composition 2 only), 1:1, 1:4 and 1:9. Production of diluted compositions with a ratio of composition:water of 1:9 was achieved in two ways:
1. Directly adding 9 parts water to 1 part stock composition; or
2. Stepwise: i.e., producing an initial dilution containing 4 parts water and 1 part stock composition and, after 1 minute, adding further water to the initial dilution to produce a further diluted composition with a composition:water ratio of 1:9.

As shown in Table 3, the viscosity of composition 2 increased upon the addition of water. Specifically, preparing diluted compositions containing a ration of composition:water of 1:0.5, 1:1 and 1:4, respectively, caused an increase in viscosity. The same increase in viscosity was not seen in composition 3 due to the lack of sodium hydroxide and resulting inability to promote gelatinization and/or solubilization of the Wheat Starch.

When preparing a 1:9 dilution of composition:water, respectively, by directly adding 9 parts water to 1 part composition 2, the result is the production of low viscosity, milky suspension followed by sedimentation of the starch granules. This is because addition of 9 parts water causes the concentration of NaOH to immediately fall below the critical concentration necessary to cause gelatinization of the starch granules. A similar result was seen when preparing a 1:9 dilution of composition 3, but this is due to the fact that there is no NaOH present in composition 3 so no gelatinization can occur regardless of the amount of water added to composition 3. However, when performing a step-wise dilution by first preparing a 1:4 dilution by adding 4 parts water to 1 part composition 2, waiting a minute, and then adding further water to produce a 1:9 dilution of composition 2 and water, respectively, an increase in viscosity is seen. This occurs as the concentration of NaOH in the 1:4 diluted composition is sufficient to cause gelatinization of the starch granules. This gelatinization is irreversible (i.e., the starch granules do not revert back to their pre-gelatinized state when the concentration of NaOH is subsequently reduced by the addition of further water) and so some degree of gelatinization will still be present in the further diluted solution despite the addition of further water producing an eventual composition containing 1 part composition 2 and 9 parts water. No gelatinization is seen when diluting composition 3 in this stepwise manner due to the absence of NaOH.

TABLE 3

| | |
|---|---|
| Dilution of | Brookfield Viscosity (mPas) |

| composition:water | Composition 2 | Composition 3 |
|---|---|---|
| 1:0 (no dilution) | 326 | 690 |
| 1:0.5 | Too thick to measure | Not measured |
| 1:1 | Too thick to measure | 25 |
| 1:4 | 2600 | 15 |
| 1:9 | 11 (granules | 11 (granules |
| | sedimenting) | sedimenting) |
| 1:9 stepwise | 410 | 11 (granules |
| | | sedimenting) |

### Example 5: Making a Low-Molecular Weight (Dextrinized) Starch Composition

A further non-limiting starch composition was prepared.

The starch composition (composition 4) was prepared using the methods used in Examples 1 and 3 except that a low molecular weight (dextrinized) starch (C*Film 07311 (89.3% dry solids) from Cargill) was used in place of Corn or Wheat Starch. A corresponding starch composition (composition 5) lacking NaOH (gelatinization promoter) was also produced. The ingredients and properties of each composition are shown in Table 4.

TABLE 4

| Ingredient | Composition 4 | Composition 5 |
|---|---|---|
| Water | 27.30 | 27.30 |
| C*Film 07311 (low molecular weight | 142.05 | 142.05 |
| (dextrinized) starch) | | |
| Glycerol | 252.50 | 252.50 |
| Sodium hydroxide solution | 78.10 | 0 |
| Total | 499.95 | 421.85 |
| Total dry solids (%) | 80 | 89 |
| pH | 12.8 | 7.1 |
| Viscosity | 326 | 150 |

### Example 6: Increasing the Viscosity of Composition 4

Water was added to compositions 4 and 5 to produce diluted compositions with the following ratios of composition:water: 1:0.2 (composition 4 only), 1:0.5 (composition 4 only), 1:1 and 1:9. Production of diluted compositions with a ratio of composition:water of 1:9 was achieved in two ways:
1. Directly adding 9 parts water to 1 part stock composition; or
2. Stepwise: i.e., producing an initial dilution containing 1 part water and 1 part stock composition and, after 1 hour, adding further water to the initial dilution to produce a further diluted composition with a composition:water ratio of 1:9.

As shown in Table 5, the initial viscosity of composition 4 is higher before the addition of water. The viscosity of the composition initially drops when adding water to produce a 1:0.2 dilution of composition 4:water, respectively. Once further diluted to produce a 1:0.5 dilution of composition 4:water, respectively, the viscosity of the composition starts to increase. Further dilution again reduces the viscosity but the product turns a yellow colour and appears less milky, which is an indication that gelatinization of the starch is occurring. The viscosity of composition 4 was measured immediately upon the addition of water. It was observed (but not measured) that the viscosity of composition 4 increased overtime and a viscous paste was formed after one to two hours, which is indicative of delayed gelatinization/solubilization of the starch granules. Conversely, no gelatinization/solubilization was seen in composition 5 due to the absence of NaOH at any time point.

When preparing a 1:9 dilution of composition:water, respectively, by directly adding 9 parts water to 1 part composition, the result is the production of low viscosity, milky suspension followed by sedimentation of the starch granules. A similar result was seen when preparing a 1:9 dilution of composition 3, due to the fact that there is no NaOH present in composition 5 so no gelatinization can occur regardless of the amount of water added to composition 5. However, when performing a step-wise dilution by first preparing a 1:1 dilution by adding 1 part water to 1 part composition 4, waiting for an hour, and then adding further water to produce a 1:9 dilution of composition 4 and water, respectively, the viscosity of the solution is still low, due to solubilization of the low molecular weight starch, but the solution is transparent. This visible difference is due to gelatinization and solubilization of the low molecular weight starch. Therefore, gelatinization/solubilization of the starch material has occurred, but this has not translated into an increase in viscosity. In contrast, there is no visible difference between the 1:9 dilution methods of composition 5 due to the absence of NaOH confirming that no gelatinization/solubilization of the starch material has occurred.

TABLE 5

| | |
|---|---|
| Dilution of | Brookfield Viscosity (mPas) |

| composition:water | Composition 4 | Composition 5 |
|---|---|---|
| 1:0 (no dilution) | 415 | 150 |
| 1:0.2 | 146 | Not measured |
| 1:0.5 | 230 | Not measured |
| 1:1 | 98 | 48 |
| 1:9 | 16 (a milky white | 15 (granules |
| | suspension is formed) | sedimenting) |
| 1:9 stepwise | 17 (a transparent | 15 (granules |
| | suspension is formed) | sedimenting) |

### Example 7: Making a Modified Starch Composition

A liquid starch composition according to the present invention was prepared.

In this non-limiting example, a composition in accordance with the present invention was prepared using the following method:
1. 168 g sodium hydroxide solution (32% dry solids) was added to 80 g of water and mixed.
2. 300 g C*Sorbidex P 16619 ((Sorbitol) 99.5% dry solids available from Cargill) was added to the prepared mixture of water and sodium hydroxide (32% dry solids) and agitated with a IKA RW28 with R 1324 propeller stirred at 800 revolutions per minute (rpm) at 30-50° C. until solubilized.
3. 142 g of a chemically modified starch (C*iGum 25800 (87% dry solids) available from Cargill) was added and agitated as above for 5 minutes at 800 rpm at room temperature until an even suspension was achieved.

The resulting composition (Composition 1) had a dry solid percentage of 69% with a water content of 31% with a Brookfield viscosity (100 rpm) of 605 mPas. See Table 6.

TABLE 6

| Table 6 | Composition 6 |
|---|---|
| Water | 80 |
| Sorbidex P 16619 | 300 |
| Starch material (C*iGum 25800 from Cargill) | 142 |
| Sodium hydroxide solution | 168 |
| Total dry solids (%) | 69% |
| Brookfield viscosity (10 minutes after production) | 605 |
| pH | 12.9 |

Due to the actions of the gelatinization inhibitor Sorbidex P 16619 (sorbitol) the viscosity of composition 6 is low meaning that composition 6 can be easily transported, handled and stored ready for downstream applications. Mixing 100 g of composition 6 with 100 g of water (a 1:1 dilution) produces a highly viscous gel/paste without having to cook the composition or add alkaline solutions. This occurs as the addition of water reduces the concentration of Sorbidex P 16619 to below a level where it is able to inhibit gelatinization/solubilization of the modified starch material while also ensuring that the concentration of NaOH is sufficient to be able to promote gelatinization/solubilization of the starch material. The viscosity of the resulting gel/paste was difficult to measure, due to the thickness of the solution, but is approximately 14350 mPas. Therefore, the viscosity of composition 6 can increased substantially simply by the addition of an equal amount of water.

Composition 6 has a high dry solid percentage (i.e., 69%) whilst also having acceptable viscosity levels. The present invention thus provides a composition with high starch concentrations that are not so viscous that they are unmanageable. The compositions of the present invention are thus extremely easy to handle and can be transported, handled and stored ready for downstream applications where the viscosity can be increased simply by the addition of water, which avoids the need to cook the starch solution and/or add highly alkaline solutions.

The compositions of the present invention are thus capable of increasing in viscosity and/or promoting gelatinization/solubilization of the starch material upon the addition of water up to a point at which either maximum swelling of the starch granules is reached or the concentration of the gelatinization promoter falls below the critical concentration to permit gelatinization/solubilization of the starch granules. This means that low-viscosity stock compositions of the claimed invention can be provided and the viscosity of these compositions can be subsequently increased in downstream applications by simply adding water. Being able to initially use a low viscosity composition will be particularly beneficial, for example, during transport, storage and handling e.g., such as pumping and initial mixing of the composition with other ingredients. To impart a higher viscosity during end use of the composition, the viscosity of the composition can be effectively “activated” (i.e., increased) simply by the addition of water. This may be achieved, by way of illustration only, by the addition of water to the stock composition before use or by mixing the stock composition, during use, with another composition that will result in an increase in the total water content of the eventual composition.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

Although certain example aspects of the invention have been described, the scope of the appended claims is not intended to be limited solely to these examples. The claims are to be construed literally, purposively, and/or to encompass equivalents.

1. A liquid composition, comprising:
starch;
a gelatinization inhibitor;
a gelatinization promoter comprising an alkali; and
a balance amount of water up to 100% by weight.

2. The composition of claim 1, wherein gelatinization of the starch occurs and/or the Brookfield viscosity of the composition increases upon the addition of water until the concentration of the gelatinization promoter falls below a critical concentration (X).

3. The composition of claim 1, wherein gelatinization of the starch occurs and/or the Brookfield viscosity increases upon the addition of water by decreasing the concentration of the gelatinization inhibitor below a critical concentration (Y) whereat the gelatinization promoter is able to promote gelatinization of the starch when the concentration of the gelatinization promoter is at or above the critical concentration (X).

4. The composition of claim 3, wherein the composition has a Brookfield viscosity (A) of less than 5000 mPas at 20-25° C. and at 100 rpm where the gelatinization inhibitor is at or above the critical concentration (Y) and a viscosity (B) that is greater than (A) where the gelatinization inhibitor is below the critical concentration (Y) and the gelatinization promoter is at or above the critical concentration (X).

5. The composition of claim 4, wherein Brookfield viscosity (B) is at least two times greater than Brookfield viscosity (A).

6. The composition of claim 4, wherein the composition has a Brookfield viscosity (C) that is less than viscosity (A) and/or (B) whereat the concentration of the gelatinization promoter is below the critical concentration (X).

7. The composition of claim 1, wherein gelatinization of the starch occurs at temperatures above 30° C.

8. The composition of claim 1, wherein the starch is a native starch.

9. (canceled)

10. The composition of claim 1, wherein the starch is a modified starch.

11. The composition of claim 10, wherein the modified starch is selected from the group consisting of: oxidized starches, acid thinned starches, thermally modified starches, a starch ether or mixtures of two or more thereof.

12. (canceled)

13. The composition of claim 1, wherein the starch is present in an amount of up to 45% by weight.

14. (canceled)

15. The composition of claim 1, wherein the gelatinization inhibitor is selected from the group consisting of: carbohydrates, alcohols, polyols, synthetic polymers and/or oligomers, amines, amides or mixtures of two or more thereof.

16. (canceled)

17. (canceled)

18. The composition of claim 15, wherein the gelatinization inhibitor comprises a polyol selected from the group consisting of: glycol, glycerol, sorbitol, mannitol, maltitol, Xylitol, erythritol, sugar alcohols, propylene glycol, ethylene glycol (EG), diethylene glycol (DEG), triethylene glycol (TEG), tetraethylene glycol or mixtures of two or more thereof.

19. The composition of claim 18, wherein the gelatinization inhibitor comprises glycerol.

20. (canceled)

21. The composition of claim 1, wherein the gelatinization inhibitor is present in an amount of up to 70% by weight.

22.-25. (canceled)

26. The composition of claim 1, wherein the composition comprises:
a. the gelatinization inhibitor at a weight percentage of from 35 to 70%;
b. starch at a weight percentage of from 20 to 35%;
c. the gelatinization promoter at a weight percentage of from 2 to 20%; and
d. water as the balance.

27.-35. (canceled)

36. A method of promoting gelatinization and/or increasing the viscosity of the composition of claim 1, the method comprising adding water to the composition or vice versa.

37. (canceled)

38. The method of claim 36, wherein water or the composition is added to the composition or water, respectively, until the concentration of gelatinization promoter is at the critical concentration (X), wherein the water or the composition is added to the composition or water, respectively, to achieve a ratio of composition:water within the range of form 1:0.1 to 1:100.

39.-41. (canceled)

42. A diluted composition comprising the composition of claim 1 and water at a ratio of composition:water within the range of from 1:0.1 to 1:100.

43. (canceled)

44. (canceled)

45. Use of the composition according to claim 1, wherein the composition is used: as an adhesive, a binder, a coating, a paper coating, in paper making, a rheology modifier, a 3D-printing material, a sealant, a material to develop a foam, to enhance oil recovery, in fertilizers, on seeds, to restrict distribution of a substance, to restrict the spread of particulates and/or solids, or as a suspension aid.
